(19) United States
(12) Patent Application Publication
(10) Pub. No.: US 2016/0148298 A1
(43) Pub. Date: May 26, 2016

(54) PHOTO BASED USER RECOMMENDATIONS

(71) Applicant: HEWLETT-PACKARD DEVELOPMENT COMPANY, L.P., Houston, TX (US)

(72) Inventors: Feng TANG, Palo Alto, CA (US); Daniel R Tretter, Palo Alto, CA (US); Jerry J Liu, Palo Alto, CA (US); Qian Lin, Palo Alto, CA (US)

(21) Appl. No.: 14/898,437

(22) PCT Filed: Jun. 20, 2013
(86) PCT No.: PCT/US2013/046781

§ 371 Date: Dec. 14, 2015

(51) Int. Cl. G06Q 30/06; G06K 9/00; G06K 9/46

(52) U.S. Cl. CPC G06Q 30/0631; G06K 9/46; G06K 9/00288

(57) ABSTRACT

Photos taken by a user over a period of time are accessed to obtain a location history and visual features of the photos. A user profile is generated from the location history and the visual features. Recommendations are provided to the user based on at least one of the location history and the user profile.

### BACKGROUND

With the increasing popularity of smartphones, tablets, and other mobile devices with image capture capabilities, users are able to take pictures almost anywhere with ease. Further, users are able to instantly share their captured images with friends and family members, or even post the images online. Thus, users may have large image collections available online (e.g., a social networking site) or offline (e.g., on a storage device).

### BRIEF DESCRIPTION OF THE DRAWINGS

The present application may be more fully appreciated in connection with the following detailed description taken in Conjunction with the accompanying drawings, in which like reference characters refer to like parts throughout and in which:

FIG. 1 is a block diagram of a device fur providing user recommendations based on a user's photos, according to one example

FIG. 2 is a block diagram of a device for providing user recommendations based on a user's photos, according to one example;

FIG. 3 is an overview of a user profile extraction workflow, according to one example;

FIG. 4 is a flowchart of a method for providing user recommendations based on a user's photos, according to one example;

FIG. 5 is a flowchart of a method fur providing user recommendations based on a user's photos, according to one example; and

FIG. 6 is a block diagram of a device including a computer-readable medium for providing user recommendations based on to user's photos, according to one example.

### DETAILED DESCRIPTION

With the increasing popularity of smartphones, photos taken by a user are automatically tagged with global positioning system (GPS) information identifying where the photo was taken. Moreover, due to the popularity and availability of photo-sharing sites and social networking sites, users are able to build a large collection of photos taken over a long period of time.

Accordingly, examples disclosed herein leverage the GPS in information and visual information available in a user's historical photo collection to generate a user profile that may include user data such as the home location, income level, activity patterns, local neighborhood demographics, age distribution, and other strong cues about the user. The generated profile information may be used to provide recommendations such as personalized services, targeted advertising, and product recommendations to the user. Further, location history obtained from the photo collection can be classified into types (e.g., park, business, residential, commercial, shopping mall, work, vacation spots, etc), such that processing recommendations can be provided to the user. As used herein, “location history” is the location (e.g., based on longitude, latitude, and GPS information) of each photo in the photo collection over the period of time of the photo collection.

By leveraging the location information extracted from the photos, follow up actions like photo sharing, tagging, and other photo processing actions may be provided to the user dynamically as photos are captured by the user. To illustrate, photos captured in a mall, for example, are more likely to be associated with shopping than photos taken at home, which are more likely to be shared and sent to flintily members. Thus, by offering more relevant recommendations to the user, the user's experience with the device may be improved.

In one example, at method includes accessing a plurality of photos taken by a user over a period of time to obtain a location history of the plurality of photos and visual features of the plurality of photos. The method also includes generating a user profile from the location history and the visual features, and providing recommendations to the user based on at least one of the location history and the user profile.

In another example, a device includes a photo analysis module to access a plurality of photos taken over a period of time and to extract location history and visual features from the photos. The device also includes a profile generation module to generate a user profile based on the location history and the visual features. The device includes a recommendation generation module to provide a plurality of recommendations to the user based on at least one of the location history and the user profile.

In another example, a non-transitory computer-readable storage medium includes instructions that, when executed by a processor of a device, causes the processor to access a photo collection of a user taken over a period of time to extract location history and visual features from the photo collection, where the photo collection is accessed from at least one of an online database and a storage medium of a computing device. The instructions are executable to generate a user profile based on the location history and the visual features, where the user profile includes demographic information of the user. The instructions are also executable to provide recommendations to the use based on at least one of the location history and the user profile.

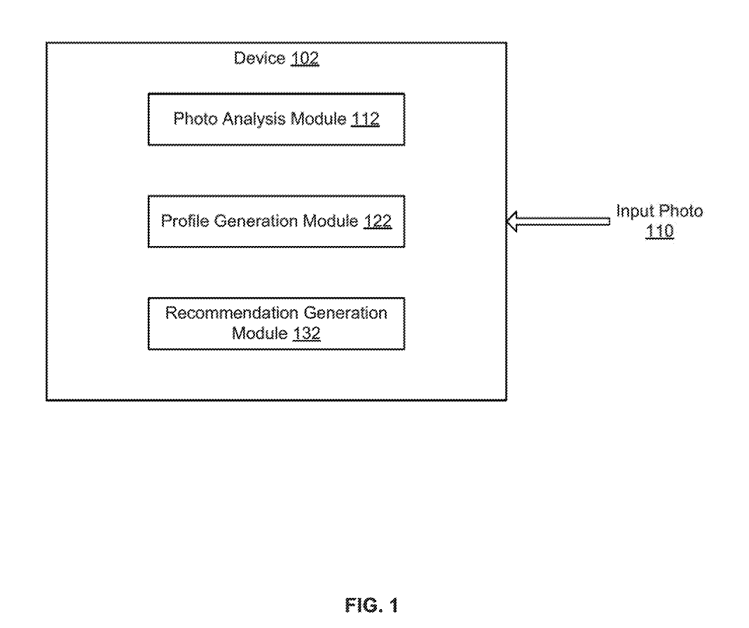

With reference to the figures, FIG. 1 is a block diagram of a device 102 for providing user recommendations based on a user's photos, according to one example. Device 102 may be, for example, a smartphone, a tablet, a cellular device, a personal digital assistant (PDA), or any portable computing device with a camera to capture images. Device 102 includes a photo analysis module 112, a profile generation module 122, and a recommendation generation module 132.

Photo analysis module 112 can be hardware and/or software for accessing a plurality of photos taken by a user over a period of time (e.g., 1 week, 1 month, 1 year, several years, etc) to obtain a location history and visual features of the photos. In one example, photo analysis module 112 may access the photos (e.g. input photo 110) from an external source such RS an online database or a storage medium of a computing device. In this example, input photo 110 may be received from a social networking site or a photo-sharing site where the user has uploaded a photo collection or from a computing device (e.g., netbook, laptop, desktop, etc) where the user has stored the photo collection. In another example, the input photo 110 may be received from a storage medium of the device 102.

Accordingly, the photo analysis module 112 can obtain a location history and visual features from the user's photo collection. Due to the presence of GPS information in the photos, location history of the photos may be obtained. Visual features of the photos may include Gabor patterns, local binary patterns (LBP), and other image content. The photo analysts module 112 may classify the location history by location types. Location types may include business, residential, recreational, vacation, educational, and commercial locations, for example. Further, the photo analysis module 112 may analyze the visual features to identify faces of individuals (e.g., friends and family members) occurring in the photo collection.

Profile generation module 122 can be hardware and/or software for generating a user profile based on the location history and the visual features. The user profile may include demographic information and other important information such as the user's home location, activity pattern, and family information, for example. The profile generation module 122 may generate the user profile by extracting geo-location features, timestamps, visual features, and metadata from the photo collection. Accordingly, the generated user profile may provide useful information about the user based on the user's photo collection.

Recommendation generation module 132 can he hardware and/or software for providing recommendations to the user based on at least one of the location history and the user profile. In one example, recommendation generation module 132 may provide personalized services, product recommendations, and targeted advertisements to the user based on the user's profile. In another example, recommendation generation module 132 may provide a photo processing recommendation for processing current or future) photos taken by the user based on the historical location types of the photo collection. To illustrate, by classifying the location by types (e.g., ‘park,’ ‘business,’ ‘residential,’ ‘shopping mall,’ etc), the purpose and appropriate processing of a photo can be estimated. Thus, if locations of past photos taken by the user are known, the location type estimate may be personalized for the user (e.g., ‘home,’ ‘work,’ ‘vacation spot,’ etc) based on the location statistics (e.g., GPS information) that determine how often photos are taken at a particular location.

Accordingly, the location types may be used to recommend follow-up actions that may be taken by the user to process a particular photo. Such follow-up actions may include photo-sharing and photo-tagging. For example, the recommendation generation module 132 may determine that photos taken at home are more likely to include family members than photos taken at work, and thus photos taken at home may he shared and/or tagged. As another example, the recommendation generation module 132 may offer more relevant processing recommendations to the user (e.g., “shop for an item online” versus “share this photo with my family”) that will greatly improve the user's photo processing experience. Further, the recommendation generation module 132 may track the user's action and associate the tracked actions to the various location types, so that the accuracy and relevancy of future recommendations to the user may be improved.

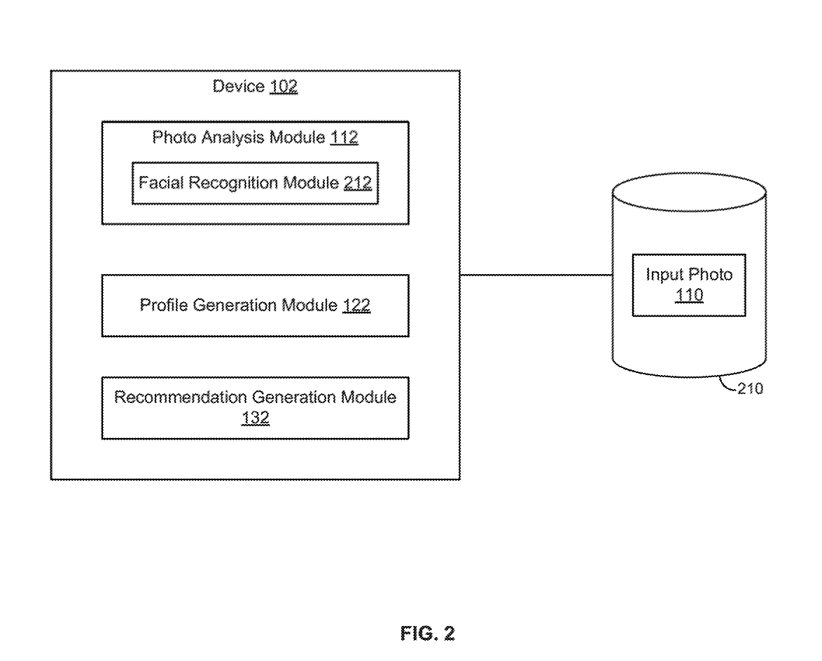

FIG. 2 is a block diagram of a device 102 for providing user recommendations based on a user's photos, according to one example. Device 142 includes the photo analysis module 112, the profile generation module 122, and the recommendation generation module 132. In the example of FIG. 2, device 102 is communicatively coupled to a database 210.

Database 210 may represent an online database that includes the user's photo collection (e.g., input photo 110), or a storage medium of a computing device that includes the input photo 110. The online database may be a social networking website, a photo-sharing website, or any website where the user may store and/or share a photo collection.

Accordingly, photo analysis module 112 may access the database 210 to get the input photo 110. From the input photo, the photo analysis module may extract location history and visual features of the input photo 110. In one example, photo analysis module 112 may include a facial recognition module 212. Facial recognition module 212 can be hardware/software for identifying faces in the input photo 110. The photo analysis module 112 may classify the location history by location types. The location types may include business, residential, recreational, vacation, educational, and commercial types.

Profile generation module 122 may generate a user profile based on the location history and the visual features. For example, the profile generation module 122 may generate a user profile by extracting geo-location features, timestamps, visual features, and other metadata from the input photo 110. The profile generation module 122 may further analyze the identified faces in the input photo 110 to generate profile information for the identified faces. The user's profile may include demographic information such as home location, home value, income level, neighborhood demographics and age distribution, marital status, activity pattern, family and friend profiles, for example.

Recommendation generation module 132 may provide recommendations to the user based on at least one of the location history and the user profile. In one example, the recommendations include at least one of a personalized service, as product recommendation, and a targeted advertisement. In another example, the recommendations include a photo processing recommendation for processing a photo taken by the user, where the photo processing recommendation includes at least one of photo tagging, photo sharing, and other user actions to be performed on the photo. The recommendation generation module 132 may track the user's actions associated with the photo to improve the quality of subsequent recommendations provided to the user.

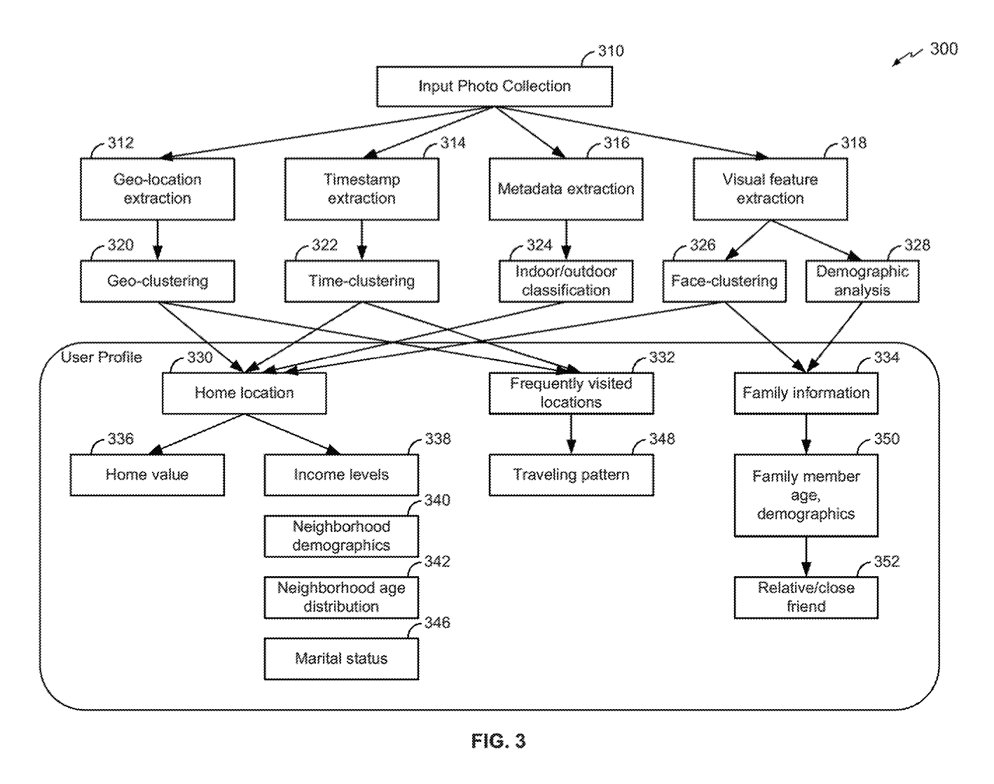

FIG. 3 is an overview of a user profile extraction workflow 300, according to one example. For each photo in the input photo collection 310, features are first extracted for further analysis. Accordingly, workflow 300 includes geo-location extraction 312, timestamp extraction 314, metadata extraction 316, and visual feature extraction 318. The extracted features 312-318 may be extracted from the photo header. For example, the extracted features 312-318 may be extracted from an exchangeable image the format (exit) header.

Geo-location features may include the latitude and longitude of a location where the photo was taken. Timestamp may include a time when the photo was taken. Time-clustering 322 may be performed on the extracted timestamps to determine when photos arc taken. Metadata may include features such as exposure time, flash on/off, and other features that may be used to determine indoor/outdoor classification 324. Visual features such as Gabor LBP patterns may be extracted based on the image content of the photo. The Gabor-LEP patterns may he used for face analysis such as face-clustering 326 and demographics 328.

The geo-locations for all the photos in the collection are aggregated into geo-clusters 320. Because the geo-locations may not be reliable, sometimes photos taken at the same location may have different latitude and longitude. However, the errors in the GPS information tend to be in a neighborhood. Accordingly, a geo-clustering method 312 (e.g., density-based spatial clustering of applications with noise (DBSCAN)) may be applied to cluster the geo-locations into clusters. Ideally, each cluster should correspond to photos taken at one physical location. Accordingly, these location clusters are candidates for the home location 330.

Thus, to determine which cluster corresponds to the home location 330, one or more of the following requirements need to be met. A cluster corresponding to the home location has to include a significant number of photos, since people tend to take a lot of photos at home over a long period of time and home is the place people spend most of their after work time. The time span for the photos in the home cluster should have a significantly long range and frequency, because people frequently take leisure photos at home. The faces appearing in a home location cluster should correspond to family members (e.g., top face clusters in the face clustering results). The location type for a home location cluster may be classified as “residential.” Based on the GPS location, reverse geo-coding may be performed to determine the address information for a latitude and longitude using readily available map applications. Further, the address can be verified using an online database to obtain the address type.

Accordingly, the home location 330 may be determined based on a combination of the geo-clustering 320, time-clustering 322, indoor/outdoor classification 324, and the face clustering 326 results. Once the home location 330 is determined, a set of user profile information can further be derived. For example, based on the home address, the house information may be retrieved. The house information may include home value 336 and number of bedrooms, home type (e.g., single family) and so on that may be retrieved from real-estate web services, for example.

In addition, the home address can be used to retrieve a set of statistical information in the neighborhood such as income levels 338, neighborhood demographics 340, neighborhood age distribution 342, and marital status, 346, for example, through census data or city/state data publicly available.

For each detected geo-cluster, the visiting frequencies of the user over a period of time may be measured. If the number of visits exceeds a certain threshold, the location may be considered a place the user frequently visits, for example. Thus, the frequently visited locations 332 may be determined based on the geo-clustering 320 and time-clustering 322 results. The frequently visited locations 332 may be further analyzed for its properties, for example, to determine whether it is a residential area, a commercial area, or an attraction location. Based on the properties, the traveling pattern 348 of the user may be derived. For example, it may be determined that the user likes to visit nearby parks on weekends.

Based on face-clustering 326 and demographic analysis 328, family information 334 may be determined. Because family members tend to be the focus of consumer photo collection, family members tend to have a lot of appearances in a user's photo collection, and hence correspond to major clusters in the face-clustering 326 result. Once the family members are determined from the family information 334, face clusters that appear at a different location and co-occur often with the family members are determined to he relatives/friends and the corresponding location is determined to be the home of the relatives/friends if the corresponding location is a residential area. Thus, family member age and demographics 350 and relatives/close friends 352 may be determined from the family information 334. It should be noted that more user profile information may be generated from the input photo collection 310 than those shown in the workflow diagram 300.

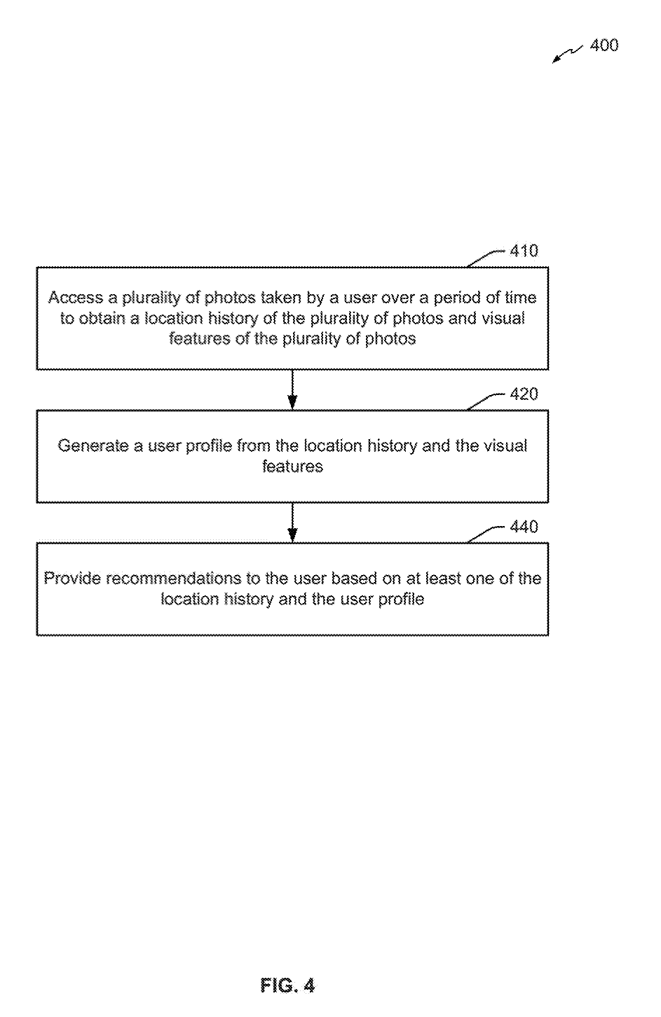

FIG. 4 is a flowchart of a method for providing user recommendations based on a user's photos, according to one example. Method 400 may be implemented in the form of executable instructions stored on a non-transitory computer-readable storage medium and/or in the form of electronic circuitry.

Method 400 includes accessing, a plurality of photos taken by a user over a period of time to obtain a location history of the plurality of photos and visual features of the plurality of photos, at 410. For example, the plurality of photos may be accessed from an online database or from a storage medium of a computing device. Location history and visual features may be extracted from the plurality of photos. Further, the location history may be classified by location type.

Method 400 includes generating a user profile from the location history and the visual features, at 420. For example, the user profile may include demographic information of the user, home location, home value, income level, neighborhood demographics and age distribution, marital status, activity pattern, hardly profile, friend profiles, and other relevant user information.

Method 400 includes providing recommendations to the user based on at least one of the location history and the user profile, at 430. In one example, the recommendations include at least one of a service recommendation, a targeted advertisement, and product recommendation based on the user profile. In another example, the recommendations include a processing recommendation for processing a photo captured by the user. In this example, the processing recommendation may include at least one of a recommendation to tag as photo, to share a photo, or to perform another processing action on the photo, based on the location type of the photo.

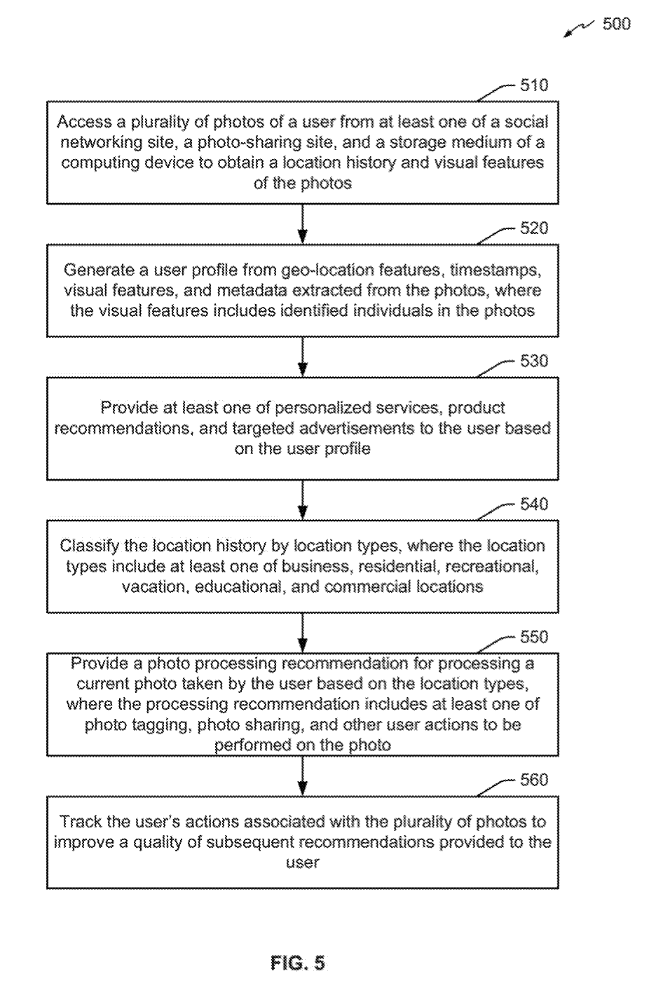

FIG. 5 is a flowchart of as method for providing user recommendations based on a user's photos, according to one example. Method 500 may be implemented in the form of executable instructions stored, on a non-transitory computer-readable storage medium and/or in the form of electronic circuitry.

Method 500 includes accessing a plurality of photos of a user from at least one of a social networking site, a photo-sharing site, and a storage medium of a computing device to obtain a location history and visual features of the photos, at 510.

Method 500 includes generating a user profile from geo-location features, timestamps, visual features, and metadata extracted from the photos, where the visual features include identified individuals in the photos, at 520. For example, facial recognition techniques may be used to identity people in the photos. Thus, the user profile may be generated based on one or more of the extracted visual features, geo-location features, times tamps, and metadata extracted from the photos.

Method 500 includes providing at least one of personalized services, product recommendations, and targeted advertisements to the user based on the user profile, at 530. Method 500 also includes classifying the location history by location types, where the location types includes at least one of business, residential, recreational, vacation, educational, and commercial locations, at 540.

Method 500 includes providing a photo processing recommendation for processing a current photo taken by the user based on the location types, where the processing recommendation includes at least one of photo tagging, photo sharing, and other user actions to be performed on the photo, at 550. Method 500 includes tracking the user's actions associated with the plurality of photos to improve a quality of subsequent recommendations provided to the user. For example, user selected actions can be tracked and associated with locations to improve future recommendations.

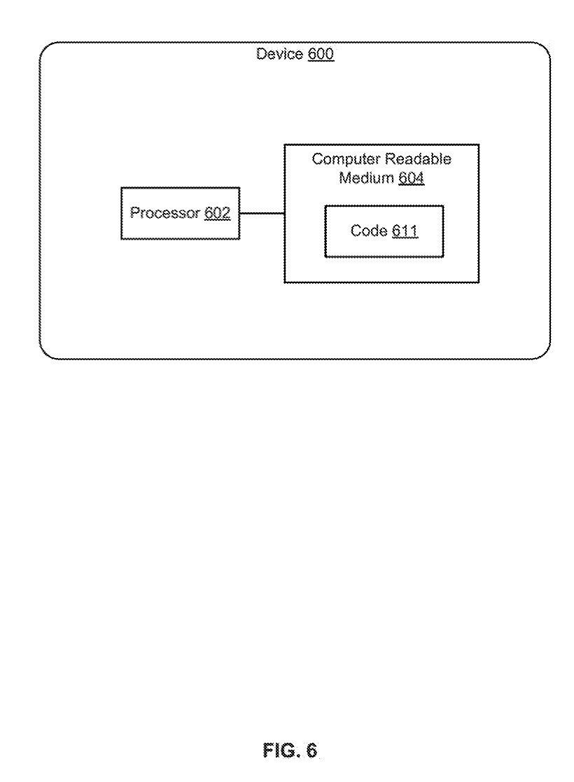

FIG. 6 is a block diagram of a device including a computer-readable medium for providing user recommendations based on a user's photos, according to one example. The device 600 can include a non-transitory computer-readable medium 604. The non-transitory computer-readable medium 604 can include code 611 that if executed by a processor 602 can cause the processor to provide recommendations to a user based on the user's photo collection. To provide the recommendations, the processor 602 may execute the code 611 to access the photo collection of the user taken over a period of time to extract location history and visual features from the photo collection. The photo collection may be accessed from at least one of an online database and a storage device of a computing device. In some examples, the photo collection may be accessed from an internal storage device of the device 600. The code 611 may further be executable by the processor 602 to generate a user profile based on the location history and the visual features, where the user profile includes demographic information of the user. The code 611 is thus executable by the processor 602 to provide recommendations to the user based on at least one of the location history and the user profile.

The techniques described above may be embodied in a computer-readable medium for configuring a computing system to execute the method. The computer-readable media may include, for example and without limitation, any number of the following non-transitive mediums: magnetic storage media including disk and tape storage media; optical storage media such as compact disk media (e.g., CD-ROM, CD-R, etc.) and digital video disk storage media; holographic memory; nonvolatile memory storage media including semiconductor-based memory units such as FLASH memory, EEPROM, EPROM, ROM; ferromagnetic digital memories; volatile storage media including registers, buffers or caches, main memory, RAM, etc.; and the Internet, just to name a few. Other new and obvious types of computer-readable media may be used to store the software modules discussed herein. Computing systems may be found in many forms including but not limited to mainframes, minicomputers, servers, workstations, personal computers, notepads, personal digital assistants, various wireless devices and embedded systems, just to name a few.

In the foregoing description, numerous details are set forth to provide an understanding of the present invention. However, it will be understood by those skilled in the art that the present invention may be practiced without these details. While the invention has been disclosed with respect to a limited number of examples, those skilled in the art will appreciate numerous modifications and variations therefrom. It is intended, that the appended claims cover such modifications and variations as fall within the true spirit and scope of the invention.

What is claimed is:

1. A method comprising:
accessing a plurality of photos taken by a user over a period of time to obtain a location history of the plurality of photos and visual features of the plurality of photos;
generating a user profile from the location history and the visual features;
providing recommendations to the user based on at least one of the location history and the user profile.

2. The method of claim 1, wherein the plurality of photos are accessed from at least one of a social networking site, a photo-sharing site, and a storage medium of a computing device.

3. The method of claim 1, comprising analyzing the visual features to identify faces of individuals in the plurality of photos, wherein the user profile includes profile information associated with the identified individuals and wherein the visual features are usable for indoor/outdoor classification of the plurality of photos.

4. The method of claim 1, wherein generating the user profile comprises extracting geo-location features, timestamps, the visual features, and metadata from the plurality of photos.

5. The method of claim 1, wherein the user profile includes demographic information of the user, and wherein the demographic information includes at least one of home location, home value, income level, neighborhood demographics and age distribution, marital status, activity pattern, family profiles, and friend profiles of the user.

6. The method of claim 5, comprising providing at least one of personalized services, product recommendations, and targeted advertisements to the user based on the user profile.

7. The method of claim 1, wherein the recommendations includes a photo processing recommendation for processing a current photo taken by the user, and wherein the photo processing recommendation includes at least one of photo tagging, photo sharing, and other user actions to be performed on the photo.

8. The method of claim 7, comprising classifying the location history by location types, wherein the location types include at least one of business, residential, recreational, vacation, educational, and commercial locations, wherein the photo processing recommendation is based on the location types.

9. The method of claim 1, comprising tracking the user's actions associated with the plurality of photos for improving a quality of subsequent recommendations provided to the user.

10. A device comprising:
a photo analysis module to:
access a plurality of photos taken over it period of time; and
extract location history and visual features from the photos;
a profile generation module to generate a user profile based on the location history and the visual features; and
a recommendation generation module to provide a plurality of recommendations to the user based on at least one of the location history and the user profile.

11. The device of claim 10, wherein the photos analysis module is to access the photos from at least one of a social networking site, an online database, and a storage medium of a computing device, and wherein the photo analysis module is to Rather to extract geo-location features, timestamps, and metadata from the photos.

12. The device of claim 10, wherein the photo analysis module includes a facial recognition module to identify individuals in the photos, wherein the user profile includes profile information for the identified individuals.

13. The device of claim 10, wherein the recommendations include:
a first recommendation for processing a current photo captured by the device:
a second recommendation that includes at least one of a service recommendation, a targeted advertisement, and a product recommendation.

14. A non-transitory computer-readable storage medium comprising instructions that, when executed by a processor of a device, causes the processor to:
access a photo collection of a user taken over a period of time to extract location history and visual features from the photo collection, wherein the photo collection is accessed from at least one of an online database and a storage medium of a computing device;
generate a user profile based on the location history and the visual features, wherein the user profile includes demographic information of the user; and
provide recommendations to the user based on at least one of the location history and the user profile.

15. The non-transitory computer-readable storage medium of claim 14, wherein the recommendations include at least one of a recommendation for processing photo captured by the device, and a location-based recommendation, wherein the processing recommendation includes at least one of tagging the photo and sharing the photo, and wherein the location-based recommendation includes at least one of a service recommendation, a product recommendation, and a targeted advertisement.
